(19) United States
(12) Patent Application Publication
(10) Pub. No.: US 2006/0003155 A1
(43) Pub. Date: Jan. 5, 2006

(54) Composite core stiffened structures for lamination and tiling

(75) Inventor: Simon Stewart, Sunrise, FL (US)

Correspondence Address: CHRISTOPHER PARADIES, PH.D., FOWLER WHITE BOGGS BANKER, P.A., 501 E KENNEDY BLVD, STE. 1900, TAMPA, FL, 33602, US

(73) Assignee: STONEFAUX, LLC, Sarasota, FL (US)

(21) Appl. No.: 11/177,609

(22) Filed: Jul. 8, 2005

(51) Int. Cl. B32B 3/26

(52) U.S. Cl. 428/304.4

(57) ABSTRACT

Composite core stiffened structures are two panels, such as fiber reinforced cement back boards, are separated by a foamed core and a stiffener. The resulting composite core is finished with a surface material that is bonded to the foamed core. The stiffness, thermal coefficient of expansion and resistance to hydration and dimensional stability with changes in humidity prevent debonding of the surface material from the composite core.

### RELATED APPLICATION

The present application claims the benefit of U.S. Provisional Application Ser. No. ______, filed Apr. 12, 2005, entitled “Composite Core for Outdoor Furniture and Method Therefor”.

### FIELD OF THE INVENTION

The field relates to fabrication of tiled countertops, tables, and other surfaces.

### BACKGROUND

It is known to use cement backer board to install tile in bathrooms. The backer board is normally adhered or fastened to a unfinished wall surface such as a stud wall or cement or brick wall. The studs or unfinished wall surface provides stiffness for the backer board such that delamination of tiles adhered to the surface of the backer board is prevented.

Furniture manufacturers have been attempting to prepare natural stone and tile surfaces on tabletops that are pre-manufactured and sold in the outdoor furniture market. However, the tabletop surfaces fail when tiles buckle or delaminate from the surface of the tabletop. There may be several reasons for delamination of a tiled or laminated surface. One reason is a mismatch in co-efficient of thermal expansion of the underlying substrate and the ceramic tiles. Another reason is that the underlying substrate is not sufficiently stiff and flexure of the underlying substrate causes the delamination of the tiles from the adhesive. Yet another reason is weathering of a substrate by changes in the humidity, which cause expansion and contraction of the substrate due to variations in the relative humidity of the surrounding air. This is particularly applicable for outdoor furniture.

Fugazzi in U.S. Pat. No. 5,976,670, discloses a fiber-reinforced concrete (FRC) as a substrate and a solid surface material (SSM) perform that is bonded to the FRC by casting the FRC into dove tail slots in the surface of the SSM perform The SSM is described as a high quality surface material such as DuPont's Corian® countertop material. The unique binding feature of the dove tail slot provides a stiff FR backing material that lowers the cost without resulting in failure of the SSM. This disclosure teaches away from use of a solid surface material without the use of the mechanical bond f a “binding feature” slot.

Takuji, U.S. Pat. No. 4,463,041, describes a resin concrete product comprising an intermediate layer composed of resin concrete and a pair of reinforcing layers composed of a fiber-reinforced plastic FRP in which the resin concrete layer is sandwiched between the FRP layers.

None of the references solve the problem of delamination of tile, stone and other solid surface materials caused by changes in temperature and humidity.

### SUMMARY OF THE INVENTION

A tabletop core is formed from two rigid panels separated by a foamed core. The foam core may be any low density foam core made of a polyurethane or polystyrene, such as encapsulated polystyrene. The rigid panels may be selected from materials having a high stiffness and strength and a coefficient of thermal expansion, resistance to moisture and density that prevents delamination of surface materials applied on the surface. For example, cement backer board or fiber reinforced cement backer board may be used as a panel for attachment of tile, natural stone and other laminate products by incorporating the backer board as one of the two rigid panels.

One advantage of a foamed core sandwich structure is that tubular stiffeners may be inserted between the stiff panels during fabrication of the core substrate. The tubular stiffeners may serve to stiffen the core while also acting as a spacer for the stiff panels. Another advantage is that the stiff panel in contact with the adhesive binding the tile or stone surfacing may be matched for coefficient of thermal expansion. Yet another advantage is that the stiff panel may be selected such that changes in relative humidity do not swell the stiff panel. Still another advantage is that a thin set adhesive between the surface finish and the stiff panel may be tailored to provide a flexible adhesive bond between the tiles and the stiffened panel of the sandwich core. The flexible adhesive bond is capable of accommodating some mechanical flexure, mismatch in thermal expansion or expansion due to changes in humidity.

Tabletops, countertops and other surfaces subjected to changes in temperature and humidity resist failures due to buckling or delamination even in outdoor applications. Stiffening of the panels which support the surface materials, such as tile is enhanced by the separation of the two stiff panels by a layer of lightweight foam. The moment of inertia increases with separation of the two stiff panels, which bond to the foam inner core.

### BRIEF DESCRIPTION OF THE DRAWINGS

The drawings illustrate examples of the present invention, but the invention should not be limited merely to the examples disclosed.

FIG. 1 illustrates a cross-section of a composite core stiffened structure.

FIG. 2 shows another cross-section.

FIGS. 3a-f illustrate various shapes of some stiffeners used in composite core stiffened structures.

FIG. 3g shows a top plan view of a stiffened structure having the upper panel removed to show a stiffener structure.

FIG. 4 shows a mold used in the formation of a sandwiched core.

FIG. 5 shows a cross-section of a table top using the sandwiched core of FIG. 2 with a cutaway view.

FIG. 6 shows a prefabricated countertop for use in residential construction.

FIG. 7 shows a prefabricated island.

FIG. 8 depicts a gaming table for outdoor use.

### DETAILED DESCRIPTION OF PREFERRED EMBODIMENTS OF THE INVENTION

The detailed descriptions and drawings provide some examples of the present invention, but the invention should not be limited merely to the examples disclosed. Instead, the invention should be limited only by the claims that may eventually issue. Many variations in the system, combinations of the various components disclosed and known and uses of the system will be readily apparent to those familiar with the area of tiled countertops, tables and other surfaces based on the drawings and description provided.

FIG. 1 illustrates a cross-section of a composite core 1. Rigid panels 2, 4 a sandwich a foamed core 6. One of the panels 2 has surface materials 8 attached to it, such as by adhesive 9 bonding. In one embodiment, the rigid panels 2, 4 are selected from materials having a stiffness, strength coefficient of thermal expansion, density, and resistance to humidity that prevents delamination of the surface materials 8 from the surface of the composite structure 2. In one example, the rigid panels 2, 4 are cement backer boards, such as fiber-reinforced cement back board produced by the Hardee Corporation.

A tubular stiffener 10 may be placed between the stiff panels 2, 4. The tubular stiffener 10 adds further stiffness and/or acts as a space during fabrication of the composite core 1.

With regard to surface materials 8, in one embodiment, the surface material 8 is made of marble. The marble may be thin, i.e., less than ⅜ inches, because it is supported by the stiff composite core. In another embodiment, the surface material 8 is a thin granite veneer. In still another embodiment, the surface material 8 is made of travertine or a ceramic. The material 8 may be applied as a thin veneer or as tiles. The tiles do not delaminate even in extremes of temperature and humidity.

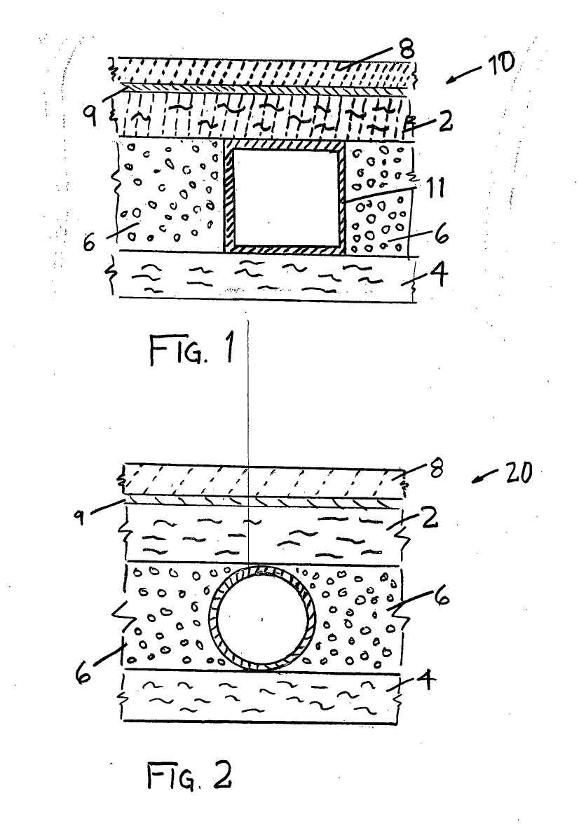

FIG. 2 depicts a cross-section of another sandwiched core 1. In one example, the rigid panels include a cement backer board. In another example, the panels include fiber reinforcement backer board. Another, tubal stiffener 20 is disposed in the foamed core between the panels. The tubular stiffener 20, has a circular cross section (not necessarily a perfect circle) having an empty center portion 12 devoid of foam 6.

In one embodiment, the foamed core may be of a polyurethane resin. In another embodiment, the core 6 may be of a polystyrene, such as encapsulated polystyrene. In still another embodiment, the core may be fiber, glass or polyester. The core 6 may be of any filler material, including air. Preferably, the core 6 serves t bind and separate the two panels 2, 4 that provide most of the stiffeners to the sandwich core 1.

In one embodiment, the surface material 8 is tile. In another example, the surface material 8 is natural stone, such as granite or marble. The surface material 8 may be an encapsulating material made of a polymer such as polyethylene or epoxy resin that provides a faux finish to the surface 8.

In one embodiment, the tubular stiffener 10 is made of metal, such as steel or aluminum The stiffener 10 may be made of any material having any shape. A board, a rod or a honey comb-shaped stiffener may be used to impart a desired stiffness to the composite core for example. A single stiffener may be used or a plurality of stiffeners may be used.

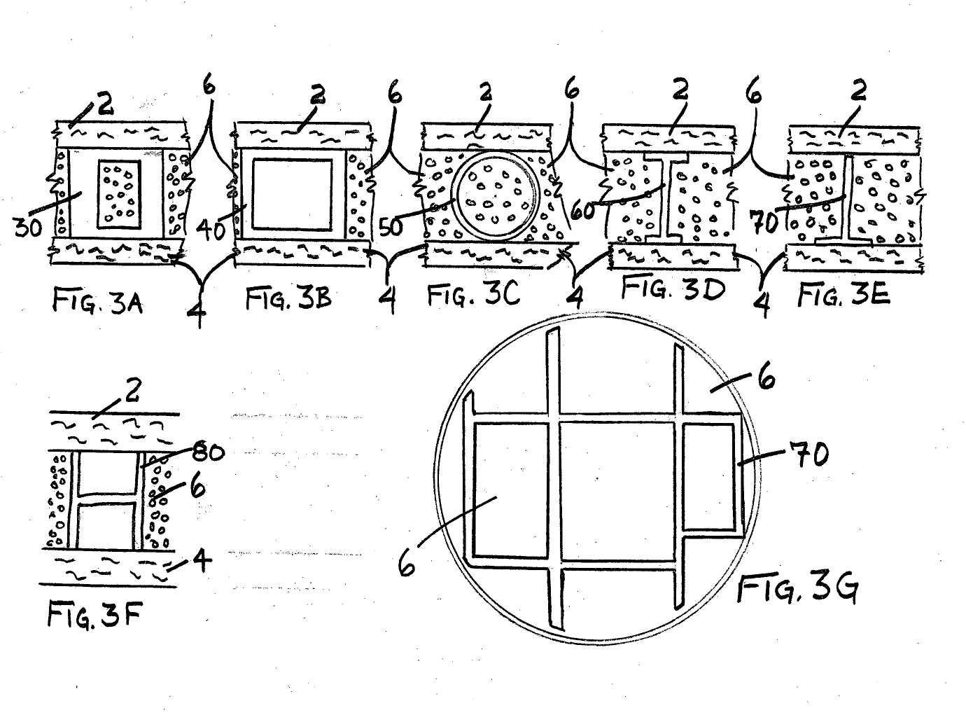

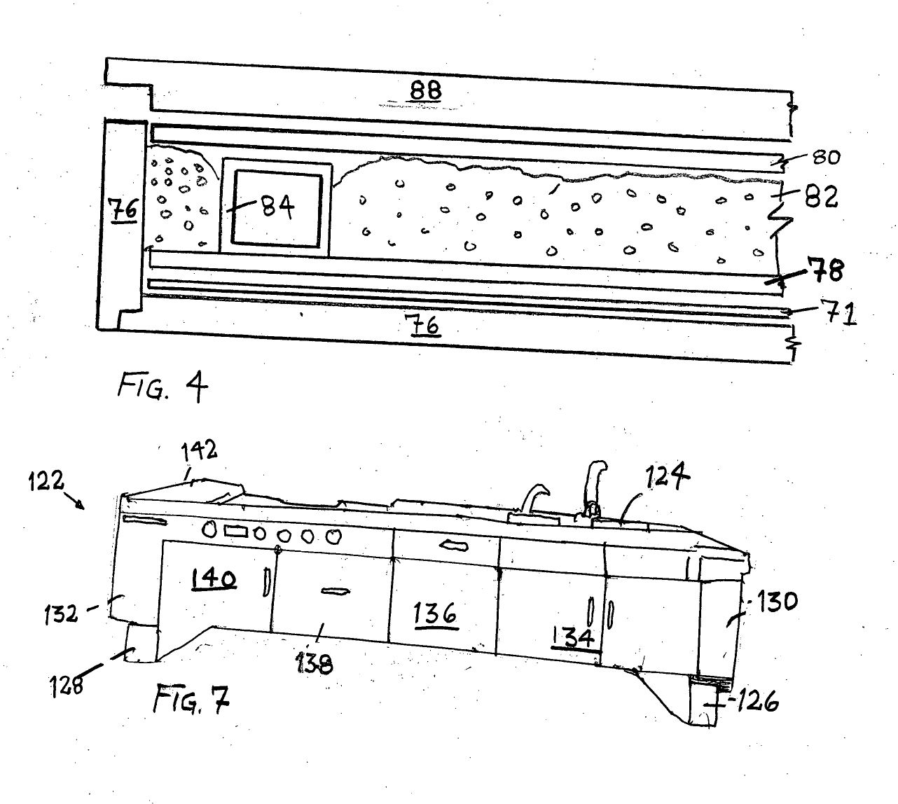

FIGS. 3A-F illustrate some different examples of the cross-sectional shapes of the stiffeners 10, 20, 30, 40, 40, 60, 70, 80. The stiffener 30 has a square. The stiffener 40 has a rectangular cross-section. The stiffener 50 has a circular cross-section. The stiffener 60 has an I-shaped cross-section. The stiffener 70 has a T-shaped (inverted) cross-section. The stiffener 80 has an H-shaped cross-section. The selection of the shape of the stiffener is known to alter the density and weight of a core 1 having a specific stiffness. More or less foamed material 6 may be present depending on the shape of the stiffener. While the drawings provide some examples, any shape may be used for a stiffener cross-section. Also, the stiffener may be a honey comb. The stiffener may not extend only in the axial direction but may form a pattern, as shown in FIG. 3G, for example.

A mold can be used for the formation of a core. In one example, the mold may be made of a polymer. In another example, the mold may be of wood, such as plywood, particle board medium density fiberboard, or high density fiberboard. In yet another example, the mold may include metal sheet.

As illustrated in FIG. 4, a mold uses a fiberboard, or any other suitable material, to size and shape the core. The mold 76 may be constructed of fiberboard or plywood and silicone rubber sealant/adhesive. A piece of fiber reinforced cement board 78, is cut to fit other mold. The cement board's thickness may be selected in any thickness that provides for adequate stiffness of the finished structure, for example, a thickness in a range of ¼ to ½ inches provides for a stiff tabletop. A second fiber-reinforced cement board may be cut to the same dimensions with the same or a different thickness. For example, the second board 88 may be selected having a greater thickness than the first board 78, because tiles may be applied to the surface of the second board 88 but not the first board 78. In one example, the second board has a thickness of about ⅜ inches and the first board has a thickness of about ¼ inches. Either or both surfaces may be tiled, and the tiles adhere to the table surfaces even with extreme changes in temperatures and relative humidity.

Before placing the first board in the mold, an appropriate quantity of expanding foam resin may be disposed into the mold on the surface of the first board 78. In one example, the resin may be a polyurethane. Stiffeners 84, 86 may be placed into the mold 76 before or after the resin. The stiffeners may range in cross section from ¼ inches to 2 inches, for example, in diameter of width such that the space between the board is likewise ¼ to 2 inches.

The fiberboard 80 may be placed on the top of the lower fiberboard 78 with the stiffeners 84, 86 and resin sandwiched between them. A mold top may be placed first thereon and a press 88 amy be used to restrict the expansion of the foam resin 82 by clamping the mold shut.

After a curing period, the composite core may be demolded. The sandwich core may then be finished into a tabletop or other assembly by adding a surface material 12.

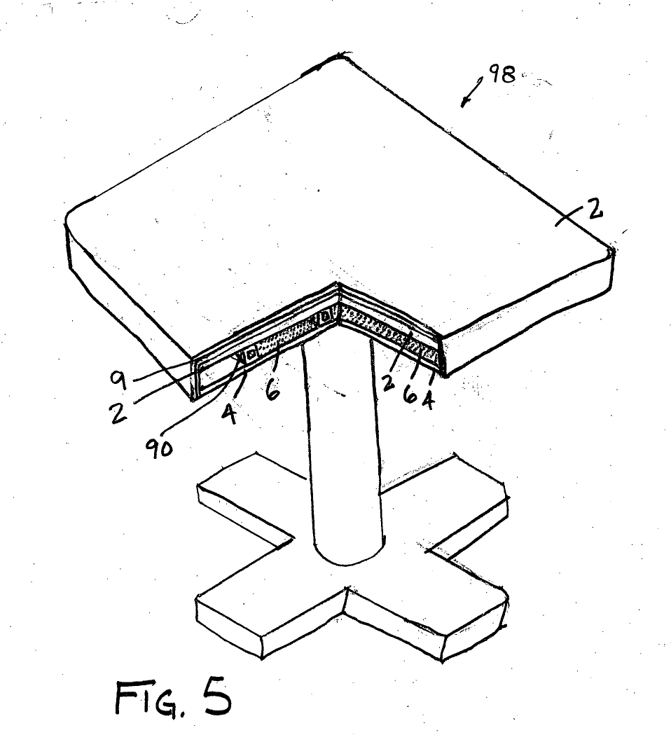

FIG. 5 depicts table 98 having surface material 2. Rigid panels 2, 4 and a foamed core 6 form a sandwich core. Stiffener 90 is shown in the foamed core 6 having one side exposed to show its extension. The sandwich core is encapsulated in a surface material 12 joined to the core by an adhesive bond 9.

In additional examples, shelves and countertops use the same sandwich core construction. In still other examples, storage cabinets and boxes use the same composite core. In one example, the surface material is a polymer that is selected to provide a faux finish, such as tile, wood, leather or a combination of these finishes. In one method, the polymer is applied directly to the first or second panel 2, 4 or both and is molded with the faux finish in the same molding step as the curing of the expandable foam core.

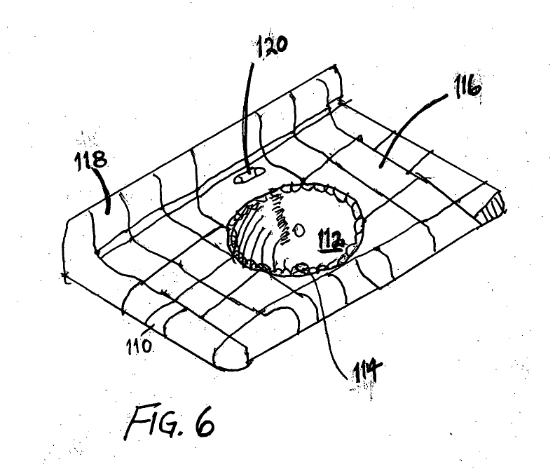

FIG. 6 shows a prefabricated countertop 110 as used in residential construction. Additionally depicted is sink 112 and tiles 114, 116, and 118. Pre-molded hole 120 may be used for assembly of faucets, for example. Fencing, pre-molded walls and other assemblies may be inexpensively and durably molded by the process disclosed. The texture may be imprinted directly from the mold form or by an interposed texture layer 71.

FIG. 7 depicts a kitchen island 122 utilizing the construction methods disclosed herein to form a countertop having pre-molded sink 124. The kitchen island further contains legs 126 and 128, support frames 130 and 132, drawers 134, 136, 138 and 140 and countertop 142.

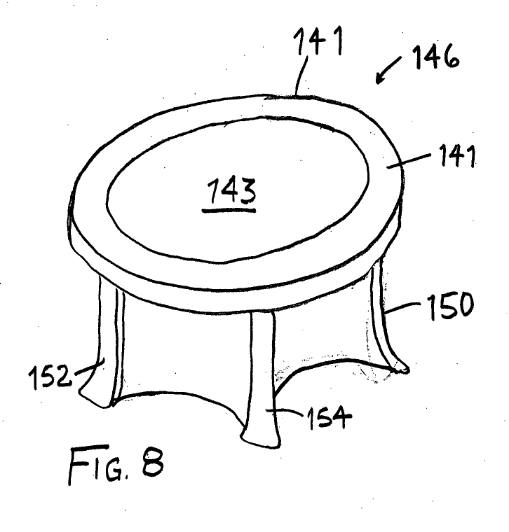

FIG. 8 illustrates a game table 144, such as a poker table. Top surface material 146 is shown having a first felt surface and a second surface that may be faux leather finish produced using a polyester encapsulating surface material 12. Additionally depicted are base member 148 and legs 150, 152 and 154. The top of the table 144 is a composite core stiffened structure 1, according to the examples provided herein. In one embodiment, the legs 150, 152, 154 are also composite core stiffened structures 1.

Alternative combinations and variations of the examples provided will become apparent based on this patent disclosure. It is not possible to provide specific examples for all of the many possible combinations and variations of the embodiments described, but such combinations and variations will be apparent to a person skilled in the field of the invention who becomes familiar with this patent disclosure.

What is claimed:

1. A structure comprising a surface material bonded to a composite core stiffened structure, the composite core stiffened structure being comprised of a first panel and a second panel, the first panel being separated from the second panel by a stiffener having a stiffener thickness and the first panel being adhered to the second panel by a foam structure disposed between the first panel and the second panel.

2. The structure of claim 1, wherein the stiffener is tubular.

3. The structure of claim 1, wherein the stiffener has a honey-comb shaped cross-section.

4. The structure of claim 1, wherein the stiffener is of a metal.

5. The structure of claim 1, wherein the stiffener is of a polymeric material.

6. The structure of claim 1, wherein the stiffener has a circular-shaped cross-section.

7. The structure of claim 1, wherein the stiffener has a square-shaped cross-section.

8. The structure of claim 1, wherein the first panel is fiber-reinforced.

9. The structure of claim 1, where the second panel is fiber-reinforced.

10. The structure of claim 1, wherein the first panel is bonded to the surface material.

11. The structure of claim 12, wherein the surface material is a tile.

12. The structure of claim 12, wherein the rigid panel is selected having coefficient of thermal expansion and a resistance to dimensional changes with changes in humidity such that delamination of the surface material is prevented.

13. The structure of claim 12, wherein the surface material is of a natural stone.

14. The structure of claim 15 wherein the natural stone is of a marble.

15. The structure of claim 15 wherein the natural stone is of a granite.

16. The structure of claim 12, wherein the surface material is of a ceramic material.

17. The structure of claim 12, wherein the surface material is of travertine.

18. The structure of claim 12 wherein the surface material is of a laminate material.

19. The structure of claim 1, wherein the foamed structure is encapsulated polystyrene.

20. The structure of claim 1, wherein a portion of the surface material has a wood grain finish.

21. The structure of claim 1, wherein a portion of the surface material has a faux leather finish.

22. A method of producing a structure comprising:
placing a first panel having an inner surface;
in a mold with the inner surface of the first panel exposed;
applying a foam forming resin on the inner surface;
inserting a stiffener in the mold on the inner surface placing a second panel on the stiffener;
positioning a lid on the mold; and
applying pressure to the lid until the resin is cured.

23. The method of claim 22, further comprising:
inserting a polymeric resin in the mold prior to the step of placing a first panel such that the first panel is encapsulated in the polymeric resin.

24. The method of claim 23, further comprising texturing the mold surface.

25. The method of claim 24, wherein the step of texturing the mold surface permanently textures the mold surface.

26. The method of claim 24, wherein the step of texturing the mold surface includes interposing a texture layer between the mold and the polymeric resin.
